(19) United States
(12) Patent Application Publication
(10) Pub. No.: US 2001/0047311 A1
(43) Pub. Date: Nov. 29, 2001

(54) Method for communicating, collaborating and transacting commerce via a communication network

(76) Inventor: Bhavesh Singh, Princeton, NJ (US)

Correspondence Address: GRAY CARY WARE & FREIDENRICH, 4365 EXECUTIVE DRIVE, SUITE 1600, SAN DIEGO, CA, 92121-2189, US

(21) Appl. No.: 09/834,487

(22) Filed: Apr. 13, 2001

Related U.S. Application Data
(60) Provisional application No. 60/196,592, filed on Apr. 13, 2000.

(51) Int. Cl. G06F 17/60

(52) U.S. Cl. 705/26

(57) ABSTRACT

A system and method providing comprehensive, end-to-end collaboration and transaction functionality for a world-wide market for products and services. Buyers suppliers and distributors are electronically connected, via a communications network for the procurement and delivery of both standard and custom products or services. Purchase orders are received at an electronic repository connected with the network, such as a website and associated memory. In response to the received purchase orders, one or more quotes are received at the repository. One method includes aggregating buyers based on a purchase order commonality, while another method includes aggregating suppliers based on capacity similarities. After a match is made and processed, a procurement transaction is executed between a buyer and one or more suppliers via electronic communication over the communications network.

### STATEMENT OF RELATED PATENT APPLICATIONS

This application claims the benefit of U.S. Provisional application Ser. No. 60/196,592, filed Apr. 13, 2000, entitled “METHOD FOR TRANSACTING COMMERCE VIA A COMMUNICATION NETWORK.”

### BACKGROUND OF THE INVENTION

1. Field of the Invention

The present invention generally relates to electronic commerce, and more particularly to a method of communicating, collaborating and transacting commerce via a communications network. This invention is directed to comprehensive, end-to-end collaboration and transaction functionality for a worldwide market for products and services.

2. Description of the Related Art

Many industries and commercial enterprises in the United States and elsewhere are characterized by fragmented supply chains and localized buyer markets. For example, in the waste water and water treatment industries in the United States, there are more than 50,000 public and private entities that supply 90% of the water needs of the population. Each of these entities is a buyer of various products and services related to waste water and water treatment. To meet their purchasing needs, buyers might rely on perhaps thousands of suppliers.

Typically, the buyers look to suppliers that are geographically close, either to the buyers themselves or to the location of a specific project, such as the construction and installation of a water treatment facility. Complexities arise where buyer and supplier are located in different geographic areas, and in particular within different countries: for example, language barriers, currency conversion rates, local rules and international shipping requirements all must be considered.

In the traditional offline procurement process for customized products, a buyer identifies its purchasing needs and mails or faxes a request for quote (“RFQ”) to local sales agents representing a limited number of independent suppliers and original equipment manufacturers (OEM). The RFQ will contain a list of specifications that the suppliers must meet in order to bid on the supply contract. For example, the buyer may seek a certain number of pipes of a particular composition, length, and diameter, and only suppliers able to supply such pipes are eligible to win the contract.

The local sales agent for each supplier then transmits the RFQ, usually by mail or fax, to a sales manager in charge of sales located in-house at the supplier's place of business. The sales manager will then typically review the RFQ and may consult with the engineering, warehouse, and logistics staff to decide whether to respond to the RFQ and, if so, what price to quote to the buyer. If a decision is made to offer a quote, the manager usually will convey the quote to the local sales agent, either by mail, fax or phone. The local sales agent then will transmit the quote back to the buyer.

Buyers typically send out several RFQs to several local sales agents and thus are delayed in making a purchasing decision until all of the potential suppliers have responded, either by submitted quotes, indicating no intention of submitting a quote, or missing the buyer imposed deadline. Usually, the time the buyer waits until all suppliers indicate a response is substantial.

After the buyer receives all of the quotes it expects to receive, it will review them and notify the local sales agent of the supplier that it considers to have the best chance of securing the contract. At that point, the local sales agent returns to the sales manager, and typically a negotiation ensues between the buyer and that supplier. Each side in the transaction may insist on numerous terms and conditions of the transaction, as well as particular representations and warranties from the other party. The negotiations can last weeks, months, or even longer. A large amount of paperwork usually is exchanged among the parties prior to and throughout the negotiations, including the original RFQ, the supplier's initial quote, product specifications, product blueprints, counteroffers, revised offers, and the like.

If negotiations break down, the buyer might contact one of the other suppliers that submitted a quote, restarting the entire negotiation process with a new supplier which may have equally disagreeable terms and conditions. The buyer may go through several iterations of this process, losing potentially critical time and incurring substantial transaction expenses. Once the buyer and a supplier agree to the general terms and conditions of the deal, the buyer will submit a purchase order to the supplier's local sales agent, typically by mail or fax. The sales agent forwards the order to the sales manager, and the sales manager generally will accept the order on behalf of the supplier.

The next step, for all but orders for the most simple equipment, parts, supplies, or the like, is usually blueprint proofing. The buyer will draft a blueprint of the item sought and will mail or fax the blueprint to the supplier for acceptance. The parties may agree on the blueprint or may seek modifications. After some time, perhaps days or weeks, the blueprint will be agreed upon. At this point, the final blueprint, other technical documentation, and an invoice will be mailed or faxed. If acceptable to both parties, the buyer and supplier will close the deal. The buyer will procure a check from its accounting or purchasing department and mail the check to the supplier, typically via the supplier's local sales agent.

This multi-stage traditional procurement process may consume anywhere from several weeks to more than 200 days or longer. The process for more complicated customized products may take still longer. Thus, the typical procurement process has enormous and costly inefficiencies. Where the buyer is a general contractor or subcontractor who itself is required to bid on a project with a quote to another buyer, any delay could jeopardize the buyer's ability to bid for or receive the project. Similarly, where a project has a tight deadline due to, for example, governmental budget constraints or weather concerns, a significant delay could be fatal to the project. For instance, where the buyer is an entity responsible for waste water treatment or the supply of safe drinking water, delay can lead to environmental and public safety hazards.

As with traditional offline procurement processes, recently-devised online procurement processes perpetuate market inefficiencies and logistical complexities. For example, one online service found at the website www.suppliermarkets.com, offers only limited transaction support. This site permits little more than matching a buyer with a supplier. After a buyer and supplier are matched by www.suppliermarket.com, they then must manually arrange for the exchange of paper-based documents, such as purchase orders, checks, and shipping information. Thus, the website's present approach results in lengthy delays, inefficient pricing, and still promotes the generation of a significant amount of paper. Further the site is presently limited to a small number of market participants.

Another online transaction site, www.wateronline.com, currently suffers from similar flaws. For example, if a user of the site desires escrow protection, the user is directed by the site to go to another third-party site to explore that possibility. Likewise, if a user desired a credit review of a buyer, the user is told to go to yet another third-party site for details. In addition, if a buyer requires products from different suppliers, the buyer is directed to different suppliers and if purchases are maid, the buyer has to process several payments and invoices and track several shippings.

Thus, conventional off-line and on-line procurement transaction systems promulgate inefficiencies by the aforementioned limitations. What is needed is a system and method for executing transactions that streamlines the procurement process, and minimizes the costs in time, materials, and human effort.

### SUMMARY OF THE INVENTION

The present invention overcomes the inefficiencies and difficulties of conventional procurement systems by providing an efficient, streamlined, and simple collaboration and procurement process that is executed over a communications network.

In accordance with one embodiment of the invention, a method includes providing a website accessible to a number of authorized buyers and authorized suppliers of products or services, receiving, in a memory associated with the website, a plurality of purchase orders from the authorized buyers, and receiving, in the memory, a number of quotes from the authorized suppliers, each quote being responsive to at least one purchase order.

The purchase orders are processed, at least in part to match at least one purchase order with at least one quote. Once processed, the method includes executing, by a processor connected with the website and according to inputs transmitted to the website from a user associated with the matched purchase order and/or quote, an electronic transaction with data from the matched purchase order and quote.

Accordingly, the invention provides collaborative communication among many buyers and suppliers of a large number of products and services, for transacting commerce over a communications network and automating steps of transaction processes for executing those transactions more efficiently.

### BRIEF DESCRIPTION OF THE DRAWING

FIG. 1 is a diagram representing one communications network in which the invention may be suitably employed.

FIG. 2 is a functional block diagram of a system according to the invention.

FIG. 3 is a flow diagram of a procurement process according to one embodiment of the invention.

FIG. 4 is a flow diagram of a procurement process according to another embodiment of the invention.

### DETAILED DESCRIPTION OF THE PREFERRED EMBODIMENTS

The present invention provides comprehensive, end-to-end collaboration and transaction functionality for a worldwide market in products and services. This invention is directed to methods for buyers, suppliers and distributors to conduct their end-to-end transactions at a virtual marketplace hosted over a communications network, such as the internet, intranets, wireless systems, or the like. It should be appreciated that the methods according to the invention can be used over a computer, personal digital assistant, wireless telephony equipment, internet-enabled television, or the like. It should also be appreciated that the methods of the invention can be used in various environments besides a web server connected to the internet and remote communications devices, such as local area networks (LANs), wide area networks (WANs), point-to-point dial-up connections, television-based systems or various other communications devices.

The invention allows buyers and suppliers to engage in transactions regardless of where they are located in the world. A buyer in Europe, for example, can request price quotes from suppliers worldwide in a timely, dynamic, and efficient manner using a communications network to post or send a request to a web server for price quotes, including precise specifications for the items desired. Suppliers can view the request by accessing the website and then respond with price quotes online for expediency. Suppliers also may receive requests for quotes via email, pagers, or other commonly-used notification methods. These requests can be automatically generated by a web server based on purchase orders posted there by potential buyers.

Suppliers need not be located in geographical proximity to the buyer or to the location where the items are needed. The invention allows the buyer to receive quotes from a virtually unlimited number of suppliers, and then to negotiate and conclude the transaction entirely online. Thus, the invention enables transactions to be executed in a timely and efficient manner. In one embodiment of the invention, buyers' requests for quotes are aggregated based on a common criteria. The criteria can include, for example, the types of goods or services being requested, the timeline in which delivery must take place, price range, or number of goods needed. Thus, the invention enables volume discounts or other favorable terms for authorized buyers from the suppliers. The invention also aggregates supplier's quotes or supply capacity data to fulfill an order. Thus, each supplier, alone, may not have to fulfill an order due to capacity limitations, and can take advantage of economies of scale.

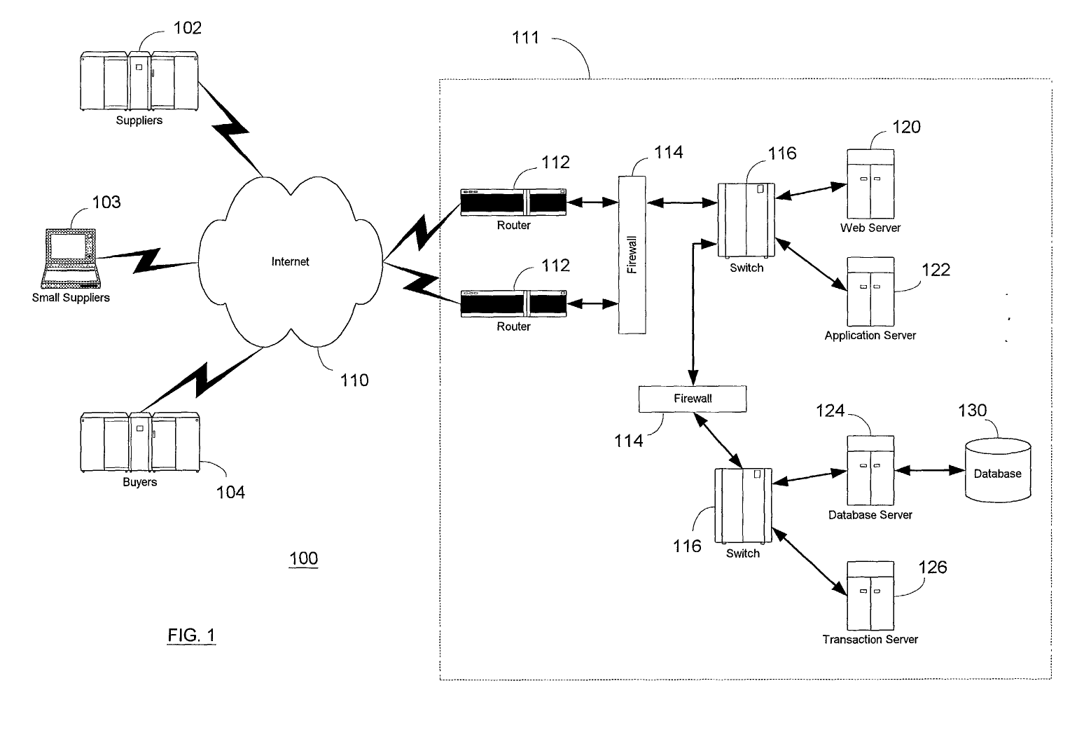

FIG. 1 is a simplified block diagram of a communications system 100 that is suitably arranged in accordance with the invention. The communications system 100 includes one or more suppliers 102, 103 communicating with one or more buyers 104 via a communications network 110. Each supplier 102 or 103 is represented as a computer system having a capability for communicating with the communications network 110. Any device or system that includes the capability of communicating with the communications network 110 can represent a supplier 102 or 103. Such devices include, without limitation, desktop computers, mainframe computers, laptop computers, handheld devices, such as cellular phones, personal digital assistants (PDAs), and pagers, etc. Likewise, any such device can also represent a buyer 104.

Within the procurement process, there is a distinction between suppliers 102 and small suppliers 103, represented here as a difference between a size of the representative computing system. However, such representation is not meant to be limiting, but merely made for exemplary reasons. The distinction of small suppliers relates to capacity instead of computing capability.

The communications network 110 is preferably the internet, such as a collection of Internet Protocol-compliant nodes known as the World Wide Web (i.e. “the Web”) which provide one or more web pages, a collection of which comprises a web site. The communications network 110 can also be an intranet, a wireless network such as a cellular system, or the like. Any communications medium that allows buyers 104 and sellers 102, 103 to communicate with one another can be suitable for the present invention. The buyers 104 and suppliers 102, 103 are connected to the communications network 110 by any communications medium. For example, suppliers may activate an option to receive notification of a posting of a purchase order via e-mail, pager, fax, or the like. Similarly, buyers may request such notification when quotes have been submitted by suppliers.

A transaction system 111 is also connected with the communications network 110. The transaction system 111 includes at least one server for communicating with the buyers and sellers, and in which procurement transactions are processed and executed. In a preferred embodiment, the transaction system 111 includes a web server 120 for providing a web site and collection of web pages accessible to each authorized buyer and seller.

An application server 122 is connected with the web server 120 via a switch 116. The application server 122 stores an application program which includes memory for storing instructions and logic for executing those instructions, for performing the methods of the invention. The application server can include, for example, a search engine for matching a list of registered suppliers with specifications provided by a number of purchase orders provided by buyers. The purchase orders can be standardized and displayed on a web page, in the form of an RFQ. In addition, suppliers who have registered can access a web site provided by the web server 120 and view a log of purchase orders that are stored and processed by the applications server 122. Each server 120 and 122 can be password protected for additional security.

The application server 122 also can include a communication program to enable online negotiations between particular buyers and particular suppliers. Once an agreement is reached as to a minimum specified parameters, such as price, quantity, etc., the parties can view a blueprint of a requested product using graphics software provided by the applications server 122. Such graphics software includes, for example, CAD/CAM, AutoCAD, or the like.

After blueprint proofing is completed, if executed, the applications server 122 facilitates creation of an electronic invoice by the supplier, for communication to the buyer. Other applications may include programs to enable coordination of shipping of the product, order tracking, language translation, escrow services, and currency conversion. Still other applications are contemplated which provide each party with an entire range of software tools to complete a transaction.

In an embodiment of the invention, the transaction system 111 also includes a database server 124 connected with a database 130, for long-term archival of transaction data, and a transaction server 126 for executing a transaction program on data stored in the database 130 and accessible from the database server 124. The database 130 is compiled to standardize the products and services expected to be transacted on the site. For example, one type of valve may have different order or part numbers depending on the manufacturer, country, or use for the valve. In one embodiment of the present invention, the database is compiled of various parts, and the system assigns its own part number to each part, or translates a non-standard number into a standard number, to standardize the data. This simplifies the ordering process so that users will not need to translate or decipher various part numbers into numbers with which they are familiar. Both the database server 124 and transaction server are connected with the web server 120 and the application server 122 via a switch 116, and to the communications network 110 for communication with authorized buyers 104 and sellers 102, 103.

Upon receipt of bids, the buyer can decide that one or more bids are acceptable and can convey this by communicating its acceptance via the website by, for example, clicking a mouse button or depressing keys on a computer keyboard. Such acceptance is promptly transmitted to the accepted supplier via the website. In the alternative, the buyer may select a subset of the suppliers to conduct subsequent rounds of bidding among suppliers. The buyer selects the subset via the website and communicates its selection to the suppliers. Suppliers indicate via the website whether they wish to participate in subsequent rounds of bidding. Subsequent bidding can be blind, static bidding, where each supplier submits a single bid. Or, subsequent bidding may be conducted dynamically for a predetermined length of time. For example, the buyer may choose to participate in a reverse auction bidding event via the website.

If the buyer chooses one supplier, it may wish to conduct further negotiations. In addition, the buyer and chosen supplier will have to agree on final price, delivery date, payment terms, shipping arrangements, and other logistical details. These details may be agreed upon via the website and executed by an application. For example, one embodiment of the present invention provides for a “deal room” wherein the buyer and supplier enter a private virtual “room” via the website. Such rooms use commercially-available technology, such as that used by America Online and numerous other internet websites.

In the room, they can communicate in real-time to finalize the transaction. After they reach agreement on terms and conditions of the transaction, the buyer and supplier transmit such acceptance via the website by, for example, clicking on an “I Accept” icon or the like displayed via the website of the present invention. Such acceptance is transmitted promptly to each party via the website. After acceptance, the supplier can transmit an online invoice to the buyer via the website. The buyer can pay the invoice via the website by means of, for example, standard online payment systems, such as those available through Identrust, Deutsche Bank, Citicorp. or Sun Trust, or via purchasing cards for small orders.

To enhance customer satisfaction, one embodiment of the present invention includes the rating of buyers and suppliers as to reliability, timeliness, and other such criteria. Thus the invention contemplates that users will have ratings known to other participants, further encouraging their reliable and credible participation. For example a supplier that has consistently delivered requested products on time and in quality condition will have a positive reputation rating and thus may generate more business, as buyers may be more willing to deal with an unfamiliar yet reputable supplier.

In another embodiment of the present invention, the site provides real time currency conversion. Thus, international market participants need not calculate currency conversions during dynamic bidding events. In another embodiment of the invention, the site provides real time language translation so that buyers and suppliers may participate even when a transaction is not carried on in their native language. Both the currency and language conversions can be effected by commercially-available currency and translation software packages. In another embodiment of the invention, market participants are offered discounts based on any market participants that they recommend and that join the site as a participant.

Other elements that can be used in the transaction system 111 include routers 112 for efficient routing of transaction data between users and the servers, and firewalls 114 for providing security and safety to communications within the system 100. The firewalls are particularly important for ensuring security within the transaction system 111. Authorized buyers and suppliers will preferably log on to a web site provided by the web server 120 and post orders via commercially available web-based security mechanisms, such as SSL/Digital Certificates. Additionally, Virtual Private Network (VPN) links could be established between the web site and a set of preferred users.

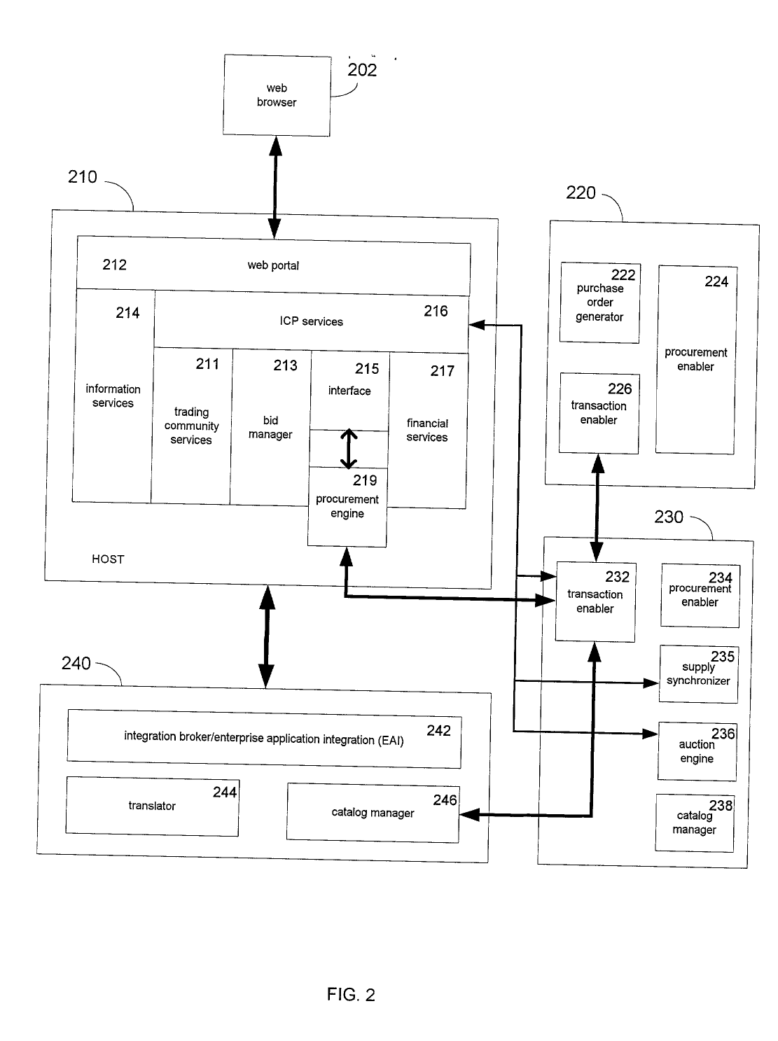

FIG. 2 is a functional block diagram of a specific embodiment of a transaction system 200 according to the invention. The transaction system 200 includes a first host platform 210, a second host platform 220, a third host platform 230, and a messaging broker 240. The host platforms are described and distinguished based on their functionality, and it should be understood that other embodiments of the invention could include more or less host platforms. For example, all of the functional modules can be included on a single host machine, or distributed among many platforms. Thus, this description is exemplary only, and should not be read to limit the invention to any particular configuration or number of host platforms.

The first host platform 210 includes a web portal 212 through which solutions such as supply chain solutions are offered and through which data formatted according to a common computer language is accessible through a web browser 202 used by a user, such as a buyer or supplier. The data can be formatted according to an internet protocol-compliant language such as HTML or XML or the like. Other alternative formats include cXML, SHTML, Internet Electronic Data Interchange (EDI), Open Buying on the Internet (OBI), Catalog Interchange Format (CIF) or the like.

The first host platform 210 also includes an information services module 214 that provides value added services such as statistical information, an ICP services module 216 that ensures authentication and logon of valid users to manage web sessions, and a trading community services module 211 that facilitates communication and collaboration amongst the users. A bid manager 213 is provided with the host and configured to manage bids and associated messages between buyers and suppliers. A financial services module 217 provides applications such as, without limitation, currency conversion, forecasting, budgeting, pricing, tax computations bill presentment and automated payments, and other services related to finances. The first host platform 210 and the functional modules it supports are accessible via host interface 215, which in turn is connected to a procurement enabler 219.

The second host platform 220 includes a purchase order generator 222 configured to generate purchase orders suitable for storage in a memory and display on a web site. The purchase order generator 222 also provides a purchase order template that is downloadable by a user, and can include fields into which a buyer can enter customized information about a particular product or service sought. The purchase order generator 222 and its associated transactions are managed by a transaction enabler 226. A procurement enabler 224 communicates with the purchase order generator 222 and the transaction enabler 226 for the proper configuration, storage and access of purchase orders received from buyers.

The third host platform 230 includes a transaction enabler 232 which is connected to the procurement engine 219, the ICP services module 216, and the purchase order transaction enabler 226. The third host platform 230 also includes a procurement enabler 234. A purchase order generator 235 is provided with the third host platform 230 to manage the purchase orders to suppliers. The purchase order generator 235 aggregates quotes that are related, such as for similar purchase orders or which offer the same type of product or service, or based on capacity, and also assists in matching supplier quotes to active purchase orders. An auction engine 236 is provided for executing and managing an auction process if selected. The auction can match purchase orders to available goods and services based on a price a buyer is willing to pay, for example. Or, the auction engine can execute a reverse auction, whereby suppliers bid the price down in order to win a contract. Other auction applications are managed by the auction engine 236. The third host platform 230 also includes a catalog manager 238.

The messaging broker 240 includes an integration broker 242 that is configured to isolate all internal messaging form all external connectivity. The messaging broker 240 also includes a message translator 244 for rapid mapping and translation of messages based on user's needs. For example, the message translator 244 can instantaneously translate a purchase order submitted by a buyer that uses a first language into a purchase order for a particular supplier that uses a second language. The messaging broker 240 can also include a catalog manager 246.

The messaging broker handles all import/export and messaging transactions over a variety of protocols, including, but not limited to, HTTP, FTP, and SMTP. The messaging broker is also configured to execute message management, such as tracking, triggering alerts, and delivery messaging, and supports translation of all transactions into any standard or customer-specific format such as fax, XML or e-mail. Additionally, the messaging broker 240 includes APIs to and from most standard back-office applications and database management tools to support the integration of the first host platform 210 into those back-office systems.

The invention includes a multi-level exchange, which enables the purchase and sale of both standard and customized products. For industry standard products, a buyer may simply enter the price and quantity desired, and the system's search engine matches the buyer's criteria with eligible suppliers. For customized products, suppliers can bid on the buyer's RFQ in a dynamic pricing event. One skilled in the art will recognize that dynamic pricing events also may be conducted for standard products. In either case, the buyer then is able to choose a supplier based on price, quantity, or other factors. It is expected that bidders will decrease prices until the price is reduced to a level that the buyer deems satisfactory. Buyers, too, may sell products (e.g., surplus products') or services (e.g., consulting) according to the systems and methods of the invention. Thus, the terms “buyer” and “supplier” should not be limited to a specific role with regards to the invention.

Further, the transaction system 200 according to the invention provides a standard classification system for inconsistently-classified parts. In addition, the present invention eliminates the problem of out-of-date and non-dynamic product catalogs traditionally used by suppliers. Authorized suppliers may dynamically post updated product catalogs to the website provided by the transaction system 200, as managed by the catalog manager 238. The system 200 can also send alert messages to interested users that a catalog has changed or has been dynamically updated.

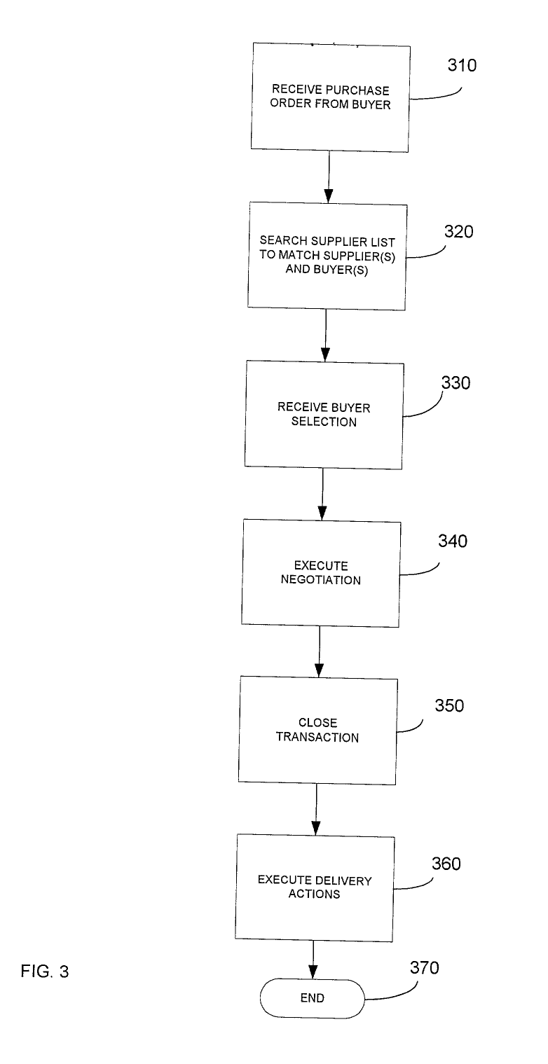

FIG. 3 is a flow diagram that illustrates one method 300 of executing a transaction, in accordance with one embodiment of the invention. At block 310, one or more buyers submit a purchase order to a website provided by the transaction system. The purchase order is preferably in the form of an RFQ. At block 320 a search engine finds qualified suppliers and displays a list of qualified suppliers on the website. At least one buyer chooses selects a supplier at block 330, and submits this selection to the website, which selection is then processed in order to enable the buyer and selected supplier to execute negotiations electronically, at block 340. The negotiations may include posting of terms and conditions, and other such details, to the website for the other party to review.

Once the negotiations are concluded, the transaction is closed at block 350. The deal closing step can include electronic verification of each party's intent to enter into an agreement. Next, delivery actions are executed at block 360. The delivery actions include exchange of technical documents, invoices, etc., and allows for payment to be made via the website electronically. Any number of electronic payment applications may be used for secure, efficient and effective exchange of currency between parties. The method ends at block 370.

Users of the website can log on and post orders via commercially available, web-based security mechanisms, such as SSL/Digital Certificates. Further security will be provided by, for example, use of a plurality of firewall devices installed at the application service provider data centers. Additionally, Virtual Private Network (VPN) links could be established between the portal site and a set of preferred partners.

When logged on to the website of the present invention, suppliers view the RFQ and decide whether to submit a quote online. The RFQ may include diagrams, photographs, video, or other graphical representations of the subject of the RFQ. This may be accomplished using standard graphics programs, such as Adobe, CAD/CAM, AutoCAD, and the like. Suppliers may opt to receive notification of the posting of an RFQ via email, pager, fax. or the like. Similarly, buyers may request such notification when quotes have been submitted. Suppliers wishing, to submit quotes in response to the RFQ type in their bids, which are transmitted to the buyer via the website, preferably within a few minutes. The buyer optionally may submit a deadline for the submission of quotes.

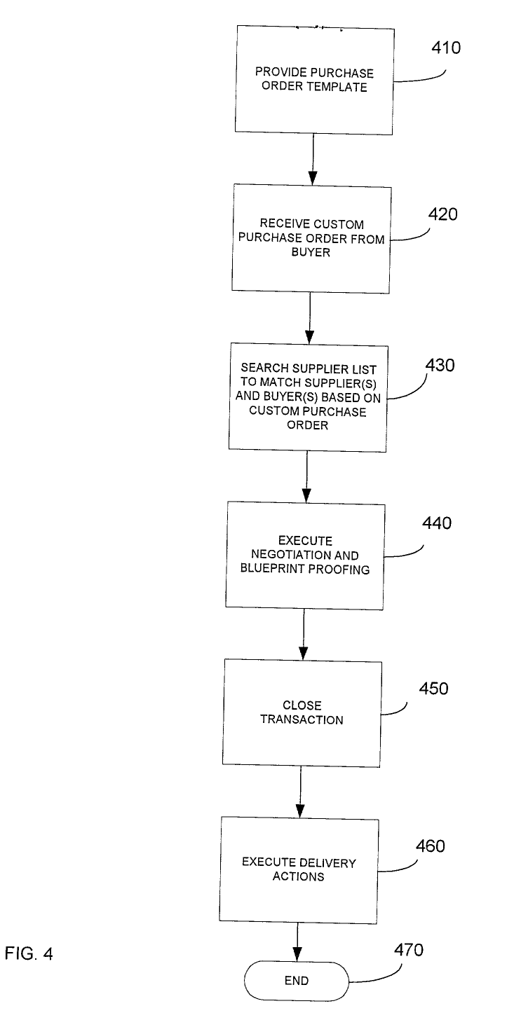

FIG. 4 is a flow diagram of a method 400 according to an alternate embodiment of the invention. The method 400 relates to customized products or services that are non-standard or not widely available. At block 410, the transaction system generates, or transmits a pre-generated, order template representing a form with blank fields configured to be filled by a buyer. The buyer completes the template to form a purchase order for the custom product or service, and transmits it back to the website at block 420. At block 430 a search is executed of suppliers to match suppliers who can accommodate the custom order. The search preferably uses the purchase order template fields, and the terms contained therein as supplied by the buyer, to canvass a database of available suppliers.

At block 440, negotiations between the buyer and matched suppliers are executed, which include blueprint proofing of the custom product or service. The blueprint proofing process includes graphically displaying, via the website, a graphic representation of the custom product or service. In one embodiment, an application may be executed within the website to display and/or manipulate the graphics. Once all of the negotiation and blueprint terms have been settled, the transaction is closed at block 450, after which the delivery actions may be executed at block 460 and as explained above. Once delivery actions are executed, the method ends at block 470.

To enhance customer satisfaction, one embodiment of the present invention includes the rating of buyers and suppliers as to reliability, timeliness, and other such criteria. Thus the invention contemplates that users will have ratings known to other participants, further encouraging their reliable and credible participation. For example, a supplier that has consistently delivered requested products on time and in quality condition will have a positive reputation rating and thus may generate more business as buyers may be more willing to deal with an unfamiliar yet reputable supplier.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

What is claimed is:

1. A method of transacting commerce via a communication network, comprising:
providing a website accessible to a plurality of authorized buyers and authorized suppliers of products or services;
receiving, in a memory associated with the website, a plurality of purchase orders from the authorized buyers;
receiving, in the memory, a plurality of quotes from the authorized suppliers, each quote being responsive to at least one purchase order;
processing the purchase orders and quotes to match at least one purchase order with at least one quote; and
executing, by a processor connected with the website and according to inputs transmitted to the website from a user associated with the matched purchase order and/or quote, an electronic transaction with data from the matched purchase order and quote.

2. The method of claim 1, wherein processing the purchase orders and quotes includes aggregating two or more purchase orders into an aggregate purchase order according to a common criteria.

3. The method of claim 1, wherein processing the purchase orders and quotes includes aggregating two or more quotes into an aggregate quote according to a common criteria.

4. The method of claim 1, wherein executing the electronic transaction includes providing, via the website, a communication medium for collaboration between users, wherein the users represent either buyers or suppliers.

5. The method of claim 1, wherein executing the electronic transaction includes coordinating transmission of payment information to the supplier from the buyer via the website.

6. The method of claim 1, wherein executing the electronic transaction includes coordinating shipping instructions between the buyer and the supplier via the website.

7. The method of claim 1, wherein executing the electronic transaction includes executing a subsequent round of bidding between at least one buyer and at least one supplier via the website.

8. The method of claim 7, wherein executing a subsequent round of bidding further includes:
soliciting, via the website, requests for bid instructions from selected buyers and/or suppliers, and
in response, receiving bid instruction inputs from the selected buyers and/or suppliers to execute a subsequent bid.

9. The method of claim 1, wherein executing the electronic transaction includes translating a purchase order and/or quote from an original language posted to the website to at least one other language.

10. The method of claim 1, wherein executing the electronic transaction includes converting a currency in a purchase order and/or quote from an original currency posted to the website to at least one other currency.

11. The method of claim 1, wherein executing the electronic transaction includes executing a confirmation routine to solicit from a buyer or a supplier confirmation of intent to execute the transaction.

12. The method of claim 1, wherein the purchase order is configured as a request for quotes (RFQ).

13. The method of claim 1, further comprising configuring a purchase order template for transmission to one or more authorized buyers.

14. The method of claim 13, wherein receiving a plurality of purchase orders includes, for at least one purchase order, receiving data within at least one empty field of the purchase order template.

15. The method of claim 14, wherein the purchase order template is stored in the memory after being filled by an authorized buyer.

16. The method of claim 1, wherein executing the electronic transaction includes displaying a graphic representation of a product or service associated with a purchase order.

17. The method of claim 16, further comprising receiving edit information at the website in response to displaying the graphic representation.

18. The method of claim 17, wherein the edit information is received from a buyer.

19. The method of claim 18, wherein the edit information is received from a supplier.

20. The method of claim 17, wherein executing the electronic transaction includes confirming a final version of the graphic representation.
